(19) United States
(12) Patent Application Publication
(10) Pub. No.: US 2026/0158299 A1
(43) Pub. Date: Jun. 11, 2026

(54) FALL PROTECTION DEVICE WITH BRUSH FOR CLEANING ROPE

(71) Applicant: YOKE INDUSTRIAL CORP., Taichung City (TW)

(72) Inventors: WEI-CHIEH HUNG, Taichung City (TW); CHIA-HSIEN WANG, Taichung City (TW); TZU-LUN WENG, Taichung City (TW)

(73) Assignee: YOKE INDUSTRIAL CORP., Taichung City (TW)

(21) Appl. No.: 18/969,296

(22) Filed: Dec. 5, 2024

(51) Int. Cl. A62B 1/10

(52) U.S. Cl. CPC A62B 1/10

(57) ABSTRACT

A fall protection device with a brush for cleaning a rope has a housing having an outlet. A fall protection device body and a deceleration device are disposed in the housing. The fall protection device body includes a main shaft fixed in the housing. A rotating hub is disposed on the main shaft. A spiral spring is connected between the main shaft and the rotating hub. A rope is wound around the rotating hub. A braking assembly is combined with a side of the rotating hub. When a rotational speed of the braking assembly is greater than a predetermined rotational speed, the deceleration device engages with the braking assembly. A brush unit having several bristles arranged in a radial manner is fixed in the outlet. When an end of the rope passes through the outlet, the end of the rope is in contact with several inner ends of the bristles.

### BACKGROUND OF THE INVENTION

### Technical Field

The present invention relates generally to a safety protective equipment, and more particularly to a fall protection device with a brush for cleaning a rope.

### Description of Related Art

When a conventional fall protection device is used, a housing of the fall protection device is fixed to a place and an end of a rope passing out of the housing is combined with a full body harness on a user. When the user wearing the full body harness falls from height, the rope is pulled to drive a rotating hub in the fall protection device to quickly rotate. At that time, a braking assembly of the rotating hub is engaged with a deceleration device fixed in the housing, to stop the rotating hub from continuously rotating and releasing the rope, so that the user could be prevented from falling continuously, thereby ensuring the safety.

If the fall protection device would indeed achieve the safety effect for the fall protection, a mechanism in the housing should normally function without any obstacle. However, because the rope is commonly released out of the housing and is commonly withdrawn into the housing during the use of the fall protection device, swarf or dust in the environment is prone to be taken into the housing during withdrawing the rope into the housing. Therefore, the function of the mechanism in the housing would be affected, which causes the safety hazard.

### BRIEF SUMMARY OF THE INVENTION

In view of the above, the primary objective of the present invention is to provide a fall protection device, wherein a device configured to clean a rope is disposed in the fall protection device, so that a mechanism installed in a housing of the fall protection device could normally function. Therefore, the fall protection device could be used more safely.

The present invention provides a fall protection device with a brush for cleaning a rope including a housing, a fall protection device body, a deceleration device, and a brush unit, wherein a receiving room is provided in the housing. A side of the housing has an outlet. The outlet communicates with the receiving room. The fall protection device body includes a main shaft, a rotating hub, a spiral spring, a rope, and a braking assembly, wherein the main shaft is fixed in the receiving room. The rotating hub rotatably fits around the main shaft. A side of the rotating hub has an installation portion. The spiral spring has two ends, wherein the two ends of the spiral spring are respectively combined with the main shaft and the rotating hub. One of two ends of the rope is combined with the rotating hub and is wound around the rotating hub to have a plurality of turns. The other end of the rope passes through the outlet. The braking assembly is combined with the installation portion. The deceleration device is fixed in the receiving room and is configured to engage with the braking assembly. The brush unit includes a brush base and a plurality of bristles, wherein the brush base is annular and is fixed in the outlet. The bristles are arranged in a radial manner. A plurality of outer ends of the bristles is fixed on the bristle base. The rope passes through an inner side of the brush base. A plurality of inner ends of the bristles is in contact with a part of the rope passing through the outlet.

With the aforementioned design, during the rope pulled by an external force from the outlet out of the housing, the rotating hub is pulled by the rope to rotate with the rope released out of the housing. When the external force pulling the rope disappears, a restoring force of the spiral spring forces the rotating hub to rotate in reverse, so that the rope having released out would be withdrawn into the housing. During the rope withdrawn by the rotating hub, the brush unit is fixed in the outlet and the inner ends of the bristles are in contact with a periphery of the rope. Therefore, through the bristles brushing a surface of the rope, swarf or dust attached on the periphery of the rope could be cleaned, so that the external swarf or the external dust could be prevented from being taken into the housing during the fall protection device body withdrawing the rope and then a cleanness inside the housing could be ensured. In this way, the fall protection device body in the housing could normally function without the obstacle from the swarf or the dust and could achieve the safety effect for the fall protection and the safety for using the fall protection device with the brush for cleaning the rope could be enhanced.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the fall protection device with the brush for cleaning the rope according to an embodiment of the present invention;

FIG. 2 is an exploded view of the fall protection device with the brush for cleaning the rope according to the embodiment of the present invention;

FIG. 3 is a perspective view of the brush module in FIG. 2;

FIG. 4 is an exploded view of the brush module in FIG. 2;

FIG. 5 is a top view of the fall protection device with the brush for cleaning the rope according to the embodiment of the present invention;

FIG. 6 is a sectional view along the 6-6 line in FIG. 5;

FIG. 6A is an enlarged view of a marked region 6A in FIG. 6;

FIG. 7 is a sectional view along the 7-7 line in FIG. 5; and

FIG. 8 is a sectional view along the 8-8 line in FIG. 5.

### DETAILED DESCRIPTION OF THE INVENTION

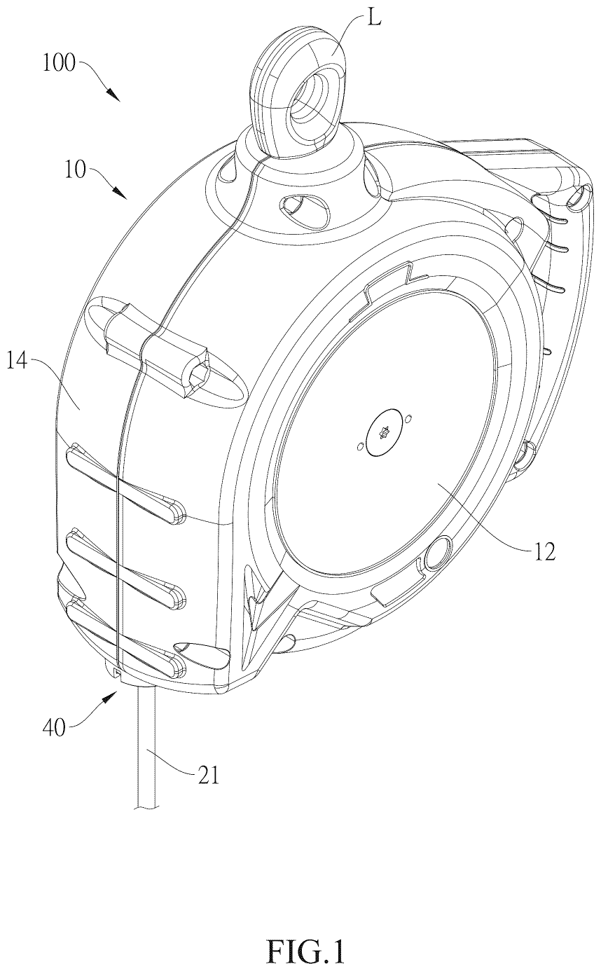

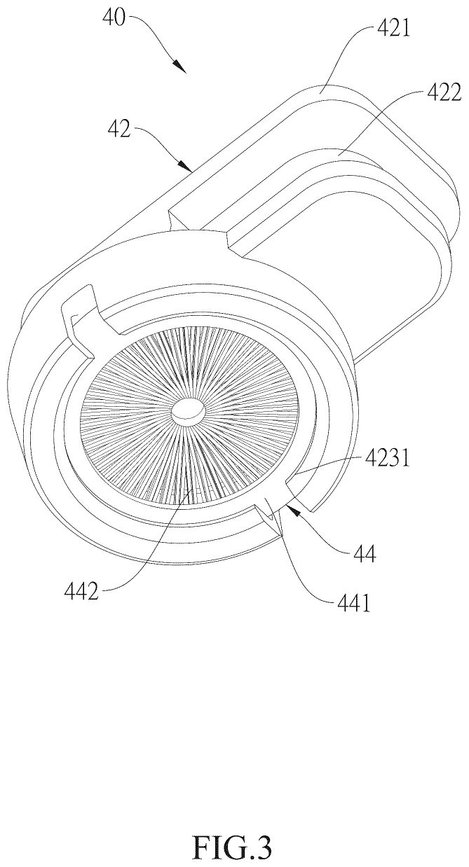

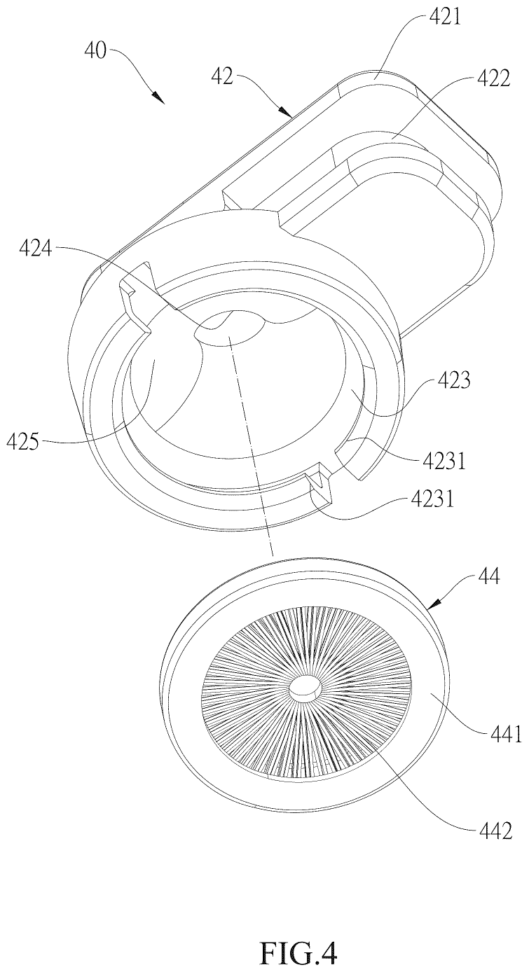

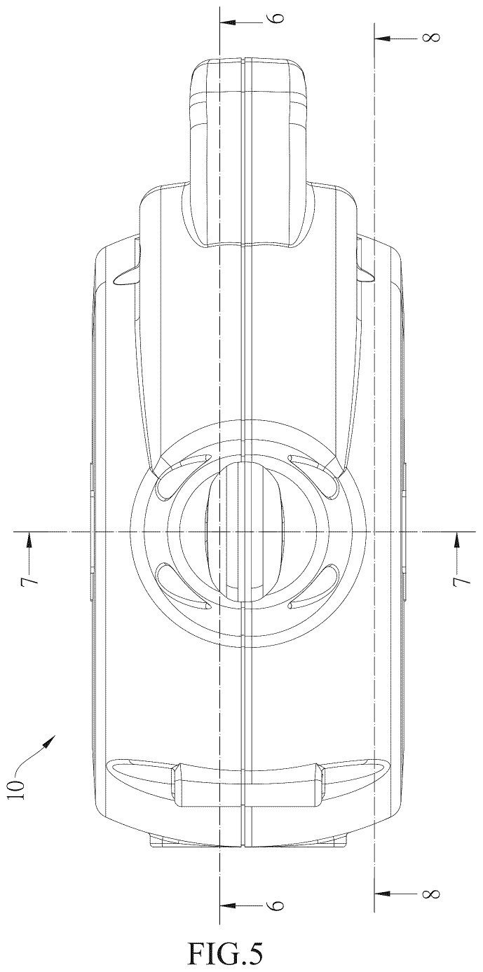

A fall protection device with a brush for cleaning a rope 100 according to an embodiment of the present invention is illustrated in FIG. 1 to FIG. 5 and includes a housing 10, a fall protection device body 20, a deceleration device 30, and a brush module 40.

The housing 10 includes two half housings 10A. A receiving room S is provided in the housing 10. The two half housings 10A are connected to each other by screwing, so that the two half housings 10A are detachable relative to each other. In other embodiments, the two half housings 10A could be connected by hooking or tenoning. Each of the two half housings 10A has a side wall 12 and a peripheral wall 14 connected to the side wall 12. The two side walls 12 of the two half housings 10A face each other. A recess 141 is formed on an edge of a bottom side of each of the two peripheral walls 14. The two recesses 141 are U-shape and are combined to form an outlet 16. A flange 161 is formed on a peripheral edge of the outlet 16. The outlet 16 communicates with the receiving room S. In the current embodiment, a top portion of the housing 10 is combined with a hanging ring L.

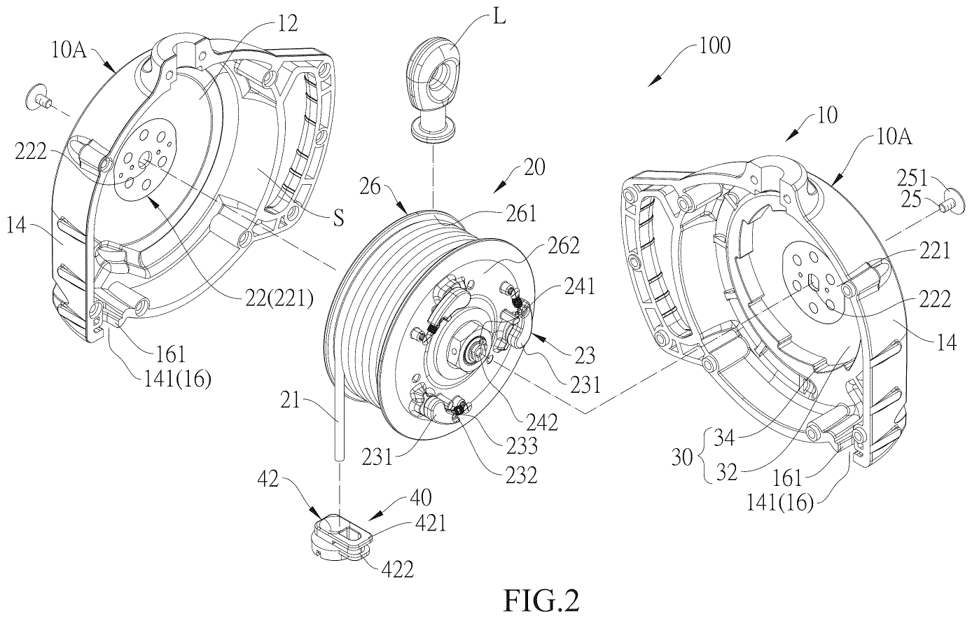

The fall protection device body 20 is disposed in the receiving room S of the housing 10. Referring to FIG. 2 and FIG. 5 to FIG. 8, the fall protection device body 20 includes a frame 22, a main shaft 24, a rotating hub 26, a spiral spring 28, a rope 21, and a braking assembly 23, wherein the frame 22 includes two plates 221. The two plates 221 are two plates with a peripheral hollow and respectively fit in a middle of each of the two side walls 12 by insert molding. A middle of each of the two plates 221 has a through hole 222, wherein each of the two through holes 222 penetrates through each of the two side walls 12. One of the two through holes 222 is a non-circular hole. In other embodiments, the two through holes 222 could be both non-circular.

Two end portions 241 are respectively formed at two ends of the main shaft 24. A shape of a periphery of each of the two end portions 241 corresponds to a shape of each of the two through holes 222. Each of the two end portions 241 fits in each of the two through holes 222. An outer end of each of the two end portions 241 has a screw hole 242. A fixing screw 25 is screwed into each of the two screw holes 242. Each of the two fixing screws 25 has a head portion 251, wherein each of the two head portions 251 abuts against a peripheral edge of each of the two through holes 222. In this way, the main shaft 24 could be fixed in the receiving room S of the housing 10 and could not rotate relative to the housing 10.

The rotating hub 26 rotatably fits around the main shaft 24. A rope groove 261 is provided around the rotating hub 26. One of two sides of the rotating hub 26 in an extending direction of the main shaft 24 has an installation portion 262, wherein the installation portion 262 is a surface perpendicular to the extending direction of the main shaft 24. The spiral spring 28 is disposed between the main shaft 24 and the rotating hub 26. One of two ends of the spiral spring 28 is combined with the main shaft 24. The other end of the spiral spring 28 is combined with the rotating hub 26. In this way, after the rotating hub 26 rotates relative to the main shaft 24, the spiral spring 28 provides a restoring force for the rotating hub 26 to rotate and restore to an initial position. The rope 21 has two ends, wherein one of the two ends of the rope 21 is combined with the rotating hub 26. The rope 21 is accommodated in the rope groove 261 and is wound around the rotating hub 26 to have a plurality of turns. The other end of the rope 21 passes through the outlet 16 of the housing 10.

The braking assembly 23 is combined with the installation portion 262 of the rotating hub 26 and faces the side wall 12 of one of the two half housings 10A. The braking assembly 23 includes three centrifugal blocks 231. The three centrifugal blocks 231 are arranged around the main shaft 24 at regular intervals. One of two ends of each of the three centrifugal blocks 231 is rotatably and pivotally connected to a periphery of the installation portion 262. A ratchet portion 232 is formed at the other end of each of the three centrifugal blocks 231. A positioning spring 233 is connected between each of the three ratchet portions 232 and the installation portion 262. In other embodiments, the number of the centrifugal blocks 231 of the braking assembly 23 could be two, four, or more, wherein the centrifugal blocks 231 are arranged around the main shaft 24 at intervals and are rotatably and pivotally connected to the periphery of the installation portion 262 in a way the same as the aforementioned embodiment.

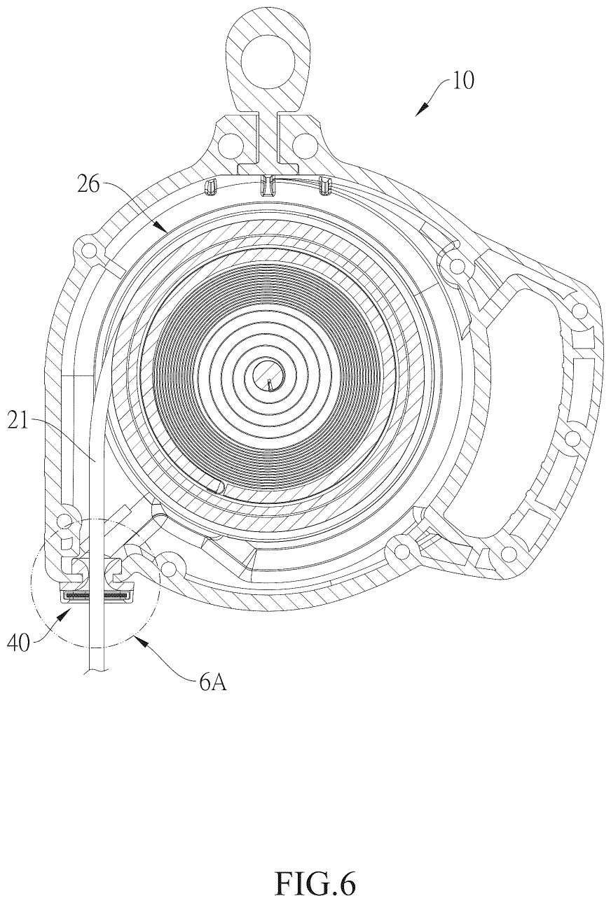

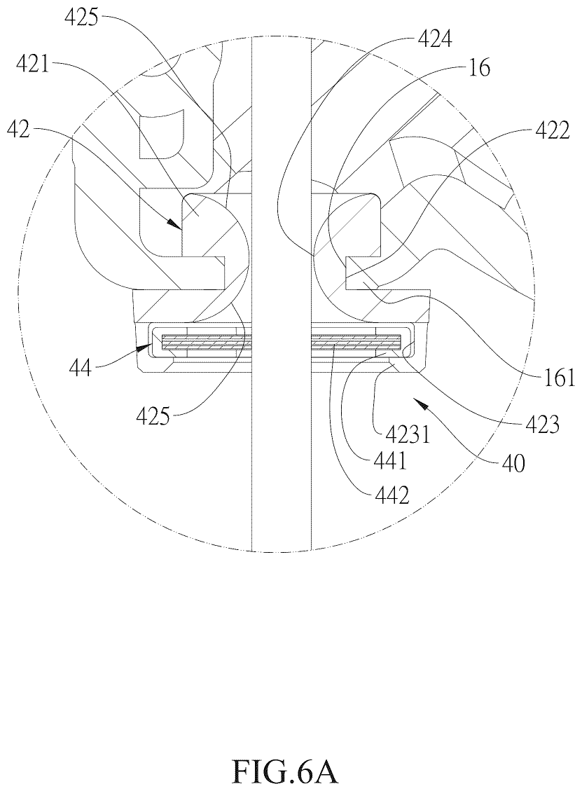

Referring to FIG. 6 to FIG. 8, when the rope 21 is pulled outwards by an external force and drives the rotating hub 26 to rotate and a rotational speed of the three centrifugal blocks 231 of the braking assembly 23 rotating with the rotating hub 26 is greater than a predetermined rotational speed, a centrifugal force acting on each of the three centrifugal blocks 231 is greater than an elastic force acting on each of the three centrifugal blocks 231 by each of the positioning springs 233. At that time, each of the three centrifugal blocks 231 rotates towards a periphery of the rotating hub 26 due to the centrifugal force, so that each of the three ratchet portions 232 moves in a direction away from the main shaft 24. In the current embodiment, the predetermined rotational speed is set under the condition that the housing 10 of the present invention is hung through the hanging ring L on a fixed location and the other end of the rope 21 passing through the outlet 16 is combined with a full body harness on a user. The predetermined rotational speed is typically set to be greater than a rotational speed at which a hand or a movement of the user pulls the rope 21 out of the outlet 16 to drive the rotating hub 26 to rotate and to be less than a rotational speed at which the user falls from height to drive the rotating hub 26 to rotate through the rope 21. In this way, the fall protection device with the brush for cleaning the rope 100 could achieve a safety effect during the person falling from height and would not hinder the user from normally working at height.

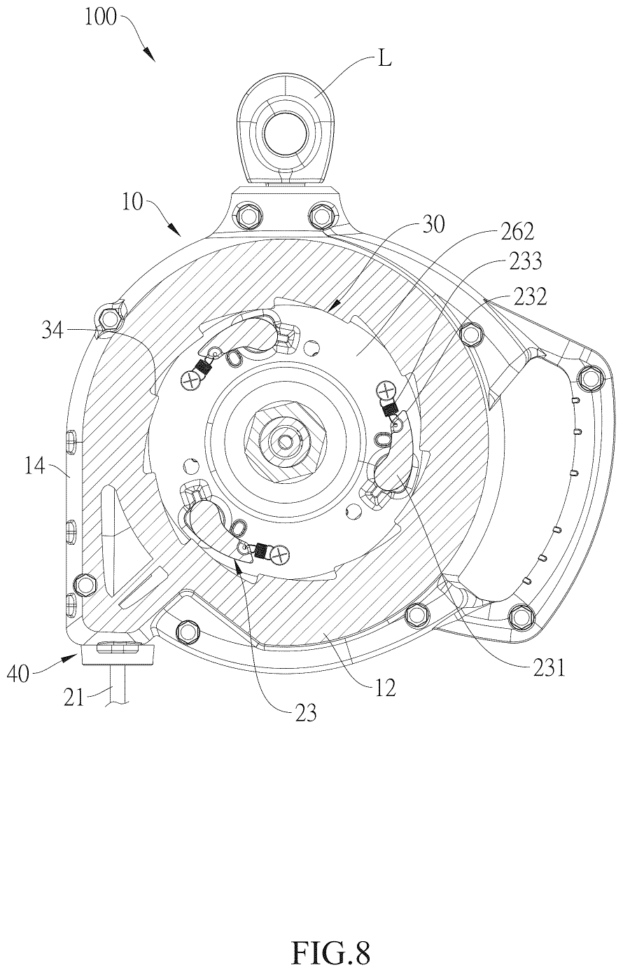

The deceleration device 30 is formed on one of the two side walls 12 facing the braking assembly 23. Referring to FIG. 2, FIG. 6, and FIG. 8, a circular groove 32 of the deceleration device 30 is formed on one of the two side walls 12. A center of the circular groove 32 and an axis of the main shaft 24 are concentric. A plurality of inner ratchets 34 is formed around an inner peripheral surface of the circular groove 32 in a consecutive manner, so that the inner ratchets 34 are fixed in the receiving room S. When the rotational speed of the three centrifugal blocks 231 of the braking assembly 23 rotating with the rotating hub 26 is greater than the predetermined rotational speed, the inner ratchets 34 of the deceleration device 30 could engage with the three centrifugal blocks 231. More specifically, when each of the three centrifugal blocks 231 are forced to rotate towards the periphery of the rotating hub 26 due to the centrifugal force, the ratchet portion 232 of each of the three centrifugal blocks 231 would engage with one of the inner ratchets 34 and the deceleration device 30 would stop the three centrifugal blocks 231 from rotating. In this way, the deceleration device 30 could achieve an effect of the deceleration of the braking assembly 23, the rotating hub 26, and the rope 21 until the braking assembly 23, the rotating hub 26, and the rope 21 stop.

In the current embodiment, the deceleration device 30 is formed on one of the two side walls 12 of the housing 10. In other embodiments, the deceleration device 30 could not be formed on one of the two side walls 12; instead, a chainring could be concentrically fixed on a periphery of the main shaft 24 through a frame; alternatively, a chainring could be fixed on one of the two side walls 12 through a frame; a plurality of inner ratchets with the same shape and in the same arrangement manner as the inner ratchets 34 is formed on an inner peripheral surface of the chainring, and the inner ratchets are also fixed in the receiving room S and are provided around the three centrifugal blocks 231 in a surrounding manner. In this way, when the rotational speed of the three centrifugal blocks 231 of the braking assembly 23 rotating with the rotating hub 26 is greater than the predetermined rotational speed, the inner ratchets of the chainring could also engage with the three centrifugal blocks 231, so that the inner ratchets of the chainring could achieve the effect of the deceleration of the braking assembly 23, the rotating hub 26, and the rope 21 until the braking assembly 23, the rotating hub 26, and the rope 21 stop.

Referring to FIG. 2 to FIG. 4, FIG. 6, and FIG. 6A, the brush module 40 includes a brush unit base 42 and a brush unit 44, wherein the brush unit base 42 has a base 421. An annular groove 422 is formed on an outer peripheral surface of the base 421 and fits around the flange 161 for fixing, so that the base 421 is fixed in the outlet 16. A brush unit groove 423 is formed on a side of the base 421 away from the receiving room S and is a circular groove of which an opening faces down. Two hooks 4231 are formed on an end edge of the brush unit groove 423 in a surrounding manner and are arranged at intervals. In other embodiments, the number of the three hooks 4231 could be more than three, wherein the hooks 4231 could be formed on the end edge of the brush unit groove 423 in a surrounding manner and be arranged at intervals. The base 421 has a rope hole 424, wherein the rope hole 424 communicates between the receiving room S and the brush unit groove 423. Two hole expansion portions 425 are respectively formed at two ends of the rope hole 424. Each of the two hole expansion portions 425 is flared.

The brush unit 44 includes a bristle base 441 and a plurality of bristles 442, wherein the bristle base 441 is annular. The bristles 442 are arranged in a radial manner. A plurality of outer ends of the bristles 442 is fixed on the bristle base 441. A gap in a shape of a circular hole is formed between a plurality of inner ends of the bristles 442. The brush unit 44 fits in the brush unit groove 423 of the brush unit base 42. A periphery of the bristle base 441 is hooked by the two hooks 4231, so that the brush unit 44 detachably fits in the brush unit groove 423.

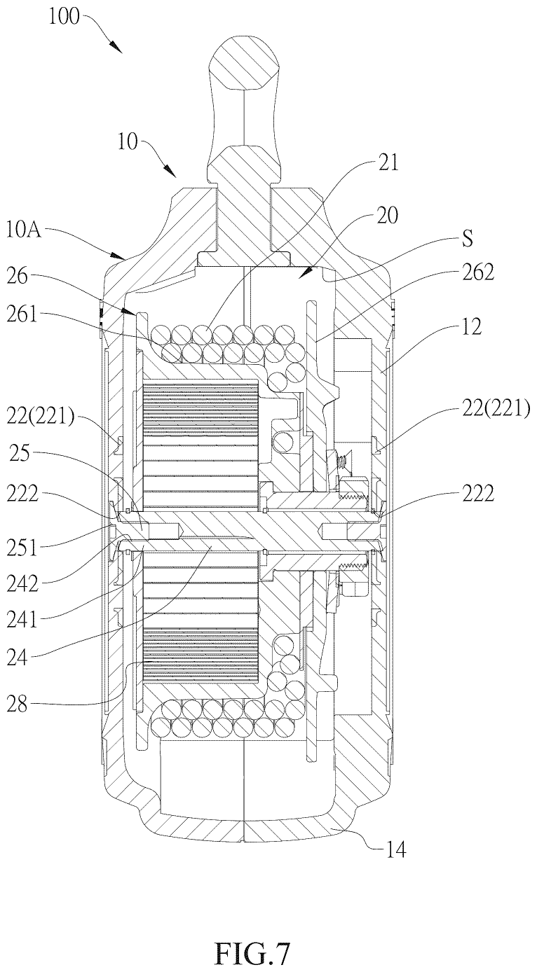

The other end of the rope 21 of the fall protection device body 20 passes through the outlet 16. More specifically, the rope 21 sequentially passes through the rope hole 424 of the brush unit base 42 and an inner side of the bristle base 441 of the brush unit 44, i.e., the circular space between the inner ends of the bristles 442, so that the inner ends of the bristles 442 are in contact with a part of the rope 21 passing through the outlet 16. Therefore, when the rope 21 passes through the outlet 16, the bristles 442 being in contact with a periphery of the rope 21 could clean a surface of the rope 21. Referring to FIG. 6, FIG. 6A, and FIG. 7, after the rope 21 is pulled out of the housing 10 by the external force, the restoring force of the spiral spring 28 could force the rotating hub 26 to roll the part of the rope 21 passing through the outlet 16 back to the housing 10. When the rope 21 is rolled back, a part of the rope 21 passing through the brush unit 44 is brushed by the bristles 442 to clean swarf or dust attached on the periphery of the rope 21, thereby preventing the rope 21 from taking the external swarf or the external dust into the housing 10. Therefore, a cleanness inside the housing 10 could be ensured, so that the fall protection device body 20 in the housing 10 could normally function without the obstacle of the swarf or the dust.

Referring to FIG. 6A, the brush unit 44 of the embodiment is detachably fixed in the brush unit groove 423 of the brush unit base 42. Therefore, when the bristles 442 are too dirty to be used after a period, the dirty brush unit 44 fitting in the brush unit groove 423 could be replaced with a new brush unit 44 and clean bristles 442 of the new brush unit 44 could clean the rope 21, so that the cleanness inside the housing 10 could be ensured and the fall protection device body 20 in the housing 10 could normally function, thereby enhancing the safety.

In the current embodiment, the brush unit 44 hooked by the two hooks 4231 fits in the brush unit groove 423. In other embodiments, the end edge of the brush unit groove 423 could be provided without the two hooks 4231; instead, an inner thread is formed on an inner peripheral surface of the brush unit groove 423, and an outer thread is formed on an outer peripheral surface of the bristle base 441, so that the brush unit 44 could be detachably combined with the brush unit groove 423 of the brush unit base 42 through the inner thread engaging with the outer thread. In addition, the brush unit groove 423 could be a rectangular groove besides the circular groove. At that time, the bristle base 441 of the brush unit 44 could be a rectangular ring, so that the brush unit 44 could firmly fit in the brush unit groove 423 and be hooked by the two hooks 4231. In addition, the brush unit base 42 could be omitted from the outlet 16; instead, the bristle base 441 of the brush unit 44 could be fixed on the peripheral edge of the outlet 16. Therefore, the part of the rope 21 passing through the outlet 16 could be in contact with the inner ends of the bristles 442 and the bristles 442 could clean the surface of the rope 21.

It must be pointed out that the embodiments described above are only some preferred embodiments of the present invention. All equivalent structures which employ the concepts disclosed in this specification and the appended claims should fall within the scope of the present invention.

What is claimed is:

1. A fall protection device with a brush for cleaning a rope, comprising:
a housing, wherein a receiving room is provided in the housing; a side of the housing has an outlet; the outlet communicates with the receiving room;
a fall protection device body comprising a main shaft, a rotating hub, a spiral spring, a rope, and a braking assembly, wherein the main shaft is fixed in the receiving room; the rotating hub rotatably fits around the main shaft; a side of the rotating hub has an installation portion; the spiral spring has two ends, wherein the two ends of the spiral spring are respectively combined with the main shaft and the rotating hub; one of two ends of the rope is combined with the rotating hub and is wound around the rotating hub to have a plurality of turns; the other end of the rope passes through the outlet; the braking assembly is combined with the installation portion;
a deceleration device fixed in the receiving room and configured to engage with the braking assembly; and
a brush unit comprising a brush base and a plurality of bristles, wherein the brush base is annular and is fixed in the outlet; the plurality of bristles are arranged in a radial manner; a plurality of outer ends of the plurality of bristles is fixed on the bristle base; the rope passes through an inner side of the brush base; a plurality of inner ends of the plurality of bristles is in contact with a part of the rope passing through the outlet.

2. The fall protection device with the brush for cleaning the rope as claimed in claim 1, wherein a brush unit base is disposed and corresponds to the brush unit; the brush unit base has a base; a periphery of the base is fixed on a peripheral edge of the outlet; a brush unit groove is formed on a side of the base away from the receiving room; the base has a rope hole, wherein the rope hole communicates between the receiving room and the brush unit groove; the brush unit is detachably fixed in the brush unit groove.

3. The fall protection device with the brush for cleaning the rope as claimed in claim 2, wherein a flange is formed on the peripheral edge of the outlet; an annular groove is formed on an outer peripheral surface of the base; the annular groove fits around the flange for fixing.

4. The fall protection device with the brush for cleaning the rope as claimed in claim 3, wherein at least two hooks are formed on an end edge of the brush unit groove in a surrounding manner and are arranged at intervals; the brush unit detachably fits in the brush unit groove; the at least two hooks hook a periphery of the brush base.

5. The fall protection device with the brush for cleaning the rope as claimed in claim 4, wherein two hole expansion portions are respectively formed at two ends of the rope hole; each of the two hole expansion portions is flared.

6. The fall protection device with the brush for cleaning the rope as claimed in claim 1, wherein the housing comprises two half housings; the two half housings are detachably connected to each other; each of the two half housings has a side wall and a peripheral wall connected to the side wall; a recess is formed on an edge of each of the two peripheral walls; the two recesses of the two half housings are combined to form the outlet.

7. The fall protection device with the brush for cleaning the rope as claimed in claim 6, wherein a brush unit base is disposed and corresponds to the brush unit; the brush unit base has a base; a periphery of the base is fixed on a peripheral edge of the outlet; a brush unit groove is formed on a side of the base away from the receiving room; the base has a rope hole, wherein the rope hole communicates between the receiving room and the brush unit groove; the brush unit is detachably fixed in the brush unit groove.

8. The fall protection device with the brush for cleaning the rope as claimed in claim 7, wherein the fall protection device body comprises a frame; the frame comprises two plates, wherein each of the two plates fits in a middle of the side wall of each of the two half housings and has a through hole; at least one of the two through holes of the two plates is non-circular; two end portions are respectively formed at two ends of the main shaft; each of the two end portions fits in the through hole of each of the two plates and has a screw hole; two fixing screws are respectively screwed into the two screw holes of the two end portions; each of the two fixing screws has a head portion, wherein the head portion of each of the two fixing screws abuts against a peripheral edge of the through hole of each of the two plates for fixing.

9. The fall protection device with the brush for cleaning the rope as claimed in claim 8, wherein the braking assembly comprises at least two centrifugal blocks; the at least two centrifugal blocks are arranged around the main shaft; one of two ends of each of the at least two centrifugal blocks is rotatably and pivotally connected to a periphery of the installation portion; a ratchet portion is formed at the other end of each of the at least two centrifugal blocks; a positioning spring is connected between the ratchet portion of each of the at least two centrifugal blocks and the installation portion; when a rotational speed of the at least two centrifugal blocks of the braking assembly rotating with the rotating hub is greater than a predetermined rotational speed, each of the at least two centrifugal blocks rotates towards a periphery of the rotating hub due to a centrifugal force and the at least two ratchet portions of the at least two centrifugal blocks engage with the deceleration device.

10. The fall protection device with the brush for cleaning the rope as claimed in claim 9, wherein the side wall of one of the two half housings faces the braking assembly; a circular groove of the deceleration device is formed on one of the two side walls of the two half housings facing the braking assembly; the circular groove and the main shaft are concentric; a plurality of inner ratchets is formed around an inner peripheral surface of the circular groove in a consecutive manner; the ratchet portion of each of the at least two centrifugal blocks engages with one of the plurality of inner ratchets of the deceleration device.
